(19) United States
(12) Patent Application Publication
(10) Pub. No.: US 2025/0054285 A1
(43) Pub. Date: Feb. 13, 2025

(54) BI-DIRECTIONAL INFORMATION FLOW AMONG UNITS OF AN AUTONOMOUS DRIVING SYSTEM

(71) Applicant: QUALCOMM Incorporated, San Diego, CA (US)

(72) Inventors: Senthil Kumar Yogamani, Headford (IE); Varun Ravi Kumar, San Diego, CA (US); Venkatraman Narayanan, Farmington Hills, MI (US)

(73) Assignee: QUALCOMM Incorporated, San Diego, CA (US)

(21) Appl. No.: 18/447,785

(22) Filed: Aug. 10, 2023

(51) Int. Cl. G06V 10/80; B60W 60/00; G06T 7/246; G06T 7/73; G06V 20/58

(52) U.S. Cl. CPC G06V 10/806; B60W 60/001; G06T 7/248; G06T 7/74; G06V 20/58; B60W 2554/00; G06T 2207/30261

(57) ABSTRACT

A sensor data processing system includes various elements, including a perception unit that collects data representing positions of sensors on a vehicle and obtains environmental information around the vehicle via the sensors. The sensor data processing system also includes a feature fusion unit that combines the first environmental information from the sensors into first fused feature data representing first positions of objects around the vehicle, provides the first fused feature data to the object tracking unit, receives feedback for the first fused feature data from the object tracking unit, and combines second environmental information from the sensors using the feedback into second fused feature data representing second positions of objects around the vehicle. The sensor data processing system may then at least partially control operation of the vehicle using the second fused feature data.

### TECHNICAL FIELD

This disclosure relates to artificial intelligence, particularly as applied to autonomous driving systems.

### BACKGROUND

Techniques are being researched and developed related to autonomous driving and advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images, depth estimation is performed to determine depths of objects in the images. Depth estimation can be performed by leveraging various principles, such as calibrated stereo imaging systems and multi-view imaging systems.

Various techniques have been used to perform depth estimation. For example, test-time refinement techniques include applying an entire training pipeline to test frames to update network parameters, which necessitates costly multiple forward and backward passes. Temporal convolutional neural networks rely on stacking of input frames in the channel dimension and bank on the ability of convolutional neural networks to effectively process input channels. Recurrent neural networks may process multiple frames during training, which is computationally demanding due to the need to extract features from multiple frames in a sequence and does not reason about geometry during inference. Techniques using an end-to-end cost volume to aggregate information during training are more efficient than test-time refinement and recurrent approaches, but are still non-trivial and difficult to map to hardware implementations.

### SUMMARY

In general, this disclosure describes techniques for processing image and/or other sensor data to determine positions of objects represented in the sensor data, relative to a position of a vehicle including the sensors that captured the sensor data. In particular, an autonomous driving system (which may be an autonomous driving assistance system) may include various units, such as a perception unit, a feature fusion unit, a scene decomposition unit, a tracking unit, a positioning unit, a prediction unit, and/or a planning unit. In conventional autonomous driving systems, data is passed linearly through such units. The techniques of this disclosure were developed based on a recognition that, in some cases, feedback from one or more later units to one or more earlier units may improve processing by the earlier units. Thus, the techniques of this disclosure include providing one or more feedback systems in a processing loop, which may improve tracking of objects across multiple views from various different sensors (e.g., cameras).

In one example, a method of processing sensor data of a vehicle includes obtaining, by a perception unit of a sensor data processing system comprising one or more processors implemented in circuitry, sensor geometry information representing positions of sensors used to collect first environmental information, the sensors being positioned on the vehicle; obtaining, by the perception unit, the first environmental information around the vehicle via the sensors; combining, by a feature fusion unit of the sensor data processing system, the first environmental information from the sensors into first fused feature data representing first positions of objects around the vehicle; providing, by the feature fusion unit and to an object tracking unit of the sensor data processing system, the first fused feature data; receiving, by the feature fusion unit and from the object tracking unit, feedback for the first fused feature data; combining, by the feature fusion unit, second environmental information from the sensors using the feedback into second fused feature data representing second positions of objects around the vehicle. In some examples, the method may include at least partially controlling, by the sensor data processing system, operation of the vehicle using the second fused feature data.

In another example, a device for processing sensor data of a vehicle includes a memory and an sensor data processing system comprising one or more processors implemented in circuitry, the sensor data processing system comprising a perception unit, a feature fusion unit, and an object tracking unit. The perception unit may be configured to: obtain sensor geometry information representing positions of sensors used to collect first environmental information, the sensors being positioned on the vehicle; and obtain the first environmental information around the vehicle via the sensors. The feature fusion unit may be configured to: combine the first environmental information from the sensors into first fused feature data representing first positions of objects around the vehicle; provide the first fused feature data to the object tracking unit; receive feedback for the first fused feature data from the object tracking unit; and combine second environmental information from the sensors using the feedback into second fused feature data representing second positions of objects around the vehicle. The sensor data processing system may further be configured to at least partially control operation of the vehicle using the second fused feature data.

In another example, a device for processing sensor data includes perception means for obtaining sensor geometry information representing positions of sensors used to collect first environmental information, the sensors being positioned on the vehicle and for obtaining the first environmental information around the vehicle via the sensors; feature fusion means for: combining the first environmental information from the sensors into first fused feature data representing first positions of objects around the vehicle; providing the first fused feature data to object tracking means; receiving, from the object tracking means, feedback for the first fused feature data; and combining second environmental information from the sensors using the feedback into second fused feature data representing second positions of objects around the vehicle. The device may further include autonomous driving means for at least partially controlling operation of the vehicle using the second fused feature data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a block diagram illustrating an example set of components of a depth determination unit.

FIG. 4 is a block diagram illustrating another example set of components that may be included in an autonomous driving controller.

FIG. 5 is a block diagram illustrating another example set of components of an autonomous driving controller according to the techniques of this disclosure.

FIG. 6 is a flowchart illustrating an example method of processing sensor data of a vehicle according to techniques of this disclosure.

### DETAILED DESCRIPTION

Depth estimation is an important component of autonomous driving (AD), autonomous driving assistance systems (ADAS), or other systems used to partially or fully autonomously control a vehicle. Depth estimation for such techniques may be used for autonomous driving, assistive robotics, augmented reality/virtual reality scene composition, image editing, or other such techniques.

This disclosure describes techniques that, rather than relying solely on object-based sensor fusion, include artificial intelligence (AI)-based multi modal bird's-eye view (BEV)-based sensor fusion. Sensor fusion generally refers to combining inputs from multiple sensors to determine locations of objects relative to an ego vehicle (e.g., a vehicle being partially or fully autonomously controlled). Conventional systems do not consider an end-to-end learnable deployment model. Likewise, conventional systems are feed-forward systems with limited or no interactions from perception modules to downstream tasks. By contrast, this disclosure describes various types of feedback mechanisms that may be used to improve object detection in an AI-based multi modal BEV-based sensor fusion system for AD or ADAS.

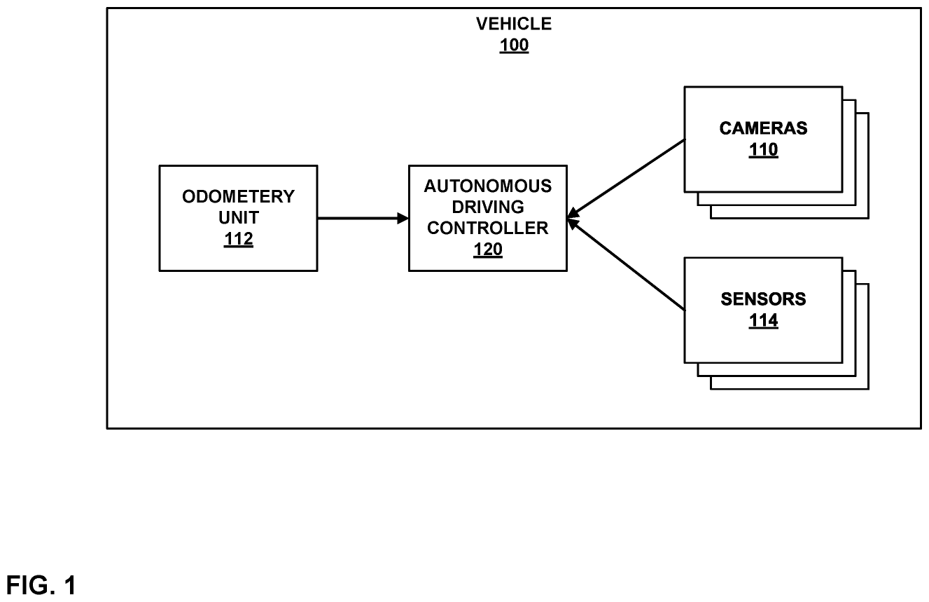

FIG. 1 is a block diagram illustrating an example vehicle 100 including an autonomous driving controller 120 according to techniques of this disclosure. Autonomous driving controller 120 may also be referred to as and/or include a sensor data processing unit. While the techniques of this disclosure are generally described with respect to autonomous driving or advanced driving assistance systems (ADAS), these techniques may also be used in other sensor processing systems.

In this example, vehicle 100 includes cameras 110, odometry unit 112, sensors 114, and autonomous driving controller 120. Cameras 110 represent multiple cameras in this example, which may be positioned at various locations on vehicle 100, e.g., in front, along the sides, and/or at the back of vehicle 100. Sensors 114 may include various other types of sensors, such as Light Detection and Ranging (LiDAR), radar, or other such sensors. In general, data collected by both cameras 110 and sensors 114 may generally be referred to as “sensor data,” while images collected by cameras 110 may also be referred to as image data.

Odometry unit 112 provides odometry data for vehicle 100 to autonomous driving controller 120. While in some cases, odometry unit 112 may correspond to a standard vehicular odometer that measures mileage traveled, in some examples, odometry unit 112 may, additionally or alternatively, correspond to a global positioning system (GPS) unit or a global navigation satellite system (GNSS) unit. In some examples, odometry unit 112 may be a fixed component of vehicle 100. In some examples, odometry unit 112 may represent an interface to a smartphone or other external device that can provide location information representing odometry data to autonomous driving controller 120.

Autonomous driving controller 120 includes various units that may collect data from cameras 110, odometry unit 112, and sensors 114 and process the data to determine locations of objects around vehicle 100 as vehicle 100 is in operation. In particular, according to the techniques of this disclosure, the various components and units of autonomous driving controller 120 may provide both feed forward and feedback flows of information. Units receiving feedback may use the feedback data when processing subsequent sets of data to improve processing performance and more accurately determine locations of objects using the feedback data.

In general, the differences between the odometry data may represent either or both of translational differences and/or rotational differences along various axis in three-dimensional space. Thus, for example, assuming that the X-axis is side-to-side of vehicle 100, the Y-axis is up and down of vehicle 100, and the Z-axis is front to back of vehicle 100, translational differences along the X-axis may represent side to side movement of vehicle 100, translational differences along the Y-axis may represent upward or downward movement of vehicle 100, and translational differences along the Z-axis may represent forward or backward movement of vehicle 100. Under the same assumptions, rotational differences about the X-axis may represent pitch changes of vehicle 100, rotational differences about the Y-axis may represent yaw changes of vehicle 100, and rotational differences about the Z-axis may represent roll changes of vehicle 100. When vehicle 100 is an automobile or other ground-based vehicle, translational differences along the Z-axis may provide the most amount of information, with rotational differences about the Y-axis may provide additional useful information (e.g., in response to turning left or right, or remaining straight).

As such, in some examples, autonomous driving controller 120 may construct a pose vector representing translational differences along each of the X-, Y-, and Z-axes between two consecutive image frames ([dX, dY, dZ]). Additionally or alternatively, autonomous driving controller 120 may construct the pose vector to include translational differences along the X- and Z-axes and rotational differences about the Y-axis ([dX, rY, dZ]). Autonomous driving controller 120 may form the pose frame to include three components, similar to RGB components or YUV/YCbCr components of an image frame. However, the pose frame may include X-, Y-, and Z-components, such that each sample of the pose frame includes the pose vector.

For example, the X-component of the pose frame may include samples each having the value of dX of the pose vector, the Y-component of the pose frame may include samples each having the value of dY or rY of the pose vector, and the Z-component of the pose frame may include samples each having the value of dZ. More or fewer components may be used. For example, the pose frame may include only a single Z-component, the Z-component and a Y-component, each of the X-, Y-, and Z-components, or one or two components per axis (e.g., either or both of the translational and/or rotational differences), or any combination thereof for any permutation of the axes.

These techniques may be employed in autonomous driving systems and/or advanced driving assistance systems (ADAS). That is, autonomous driving controller 120 may autonomously control vehicle 100 or provide feedback to a human operator of vehicle 100, such as a warning to brake or turn if an object is too close. Additionally or alternatively, the techniques of this disclosure may be used to partially control vehicle 100, e.g., to maintain speed of vehicle 100 when no objects within a threshold distance are detected ahead of vehicle 100, or if a separate vehicle is detected ahead of vehicle 100, to match the speed of the separate vehicle if the separate vehicle is within the threshold distance, to prevent reducing the distance between vehicle 100 and the separate vehicle.

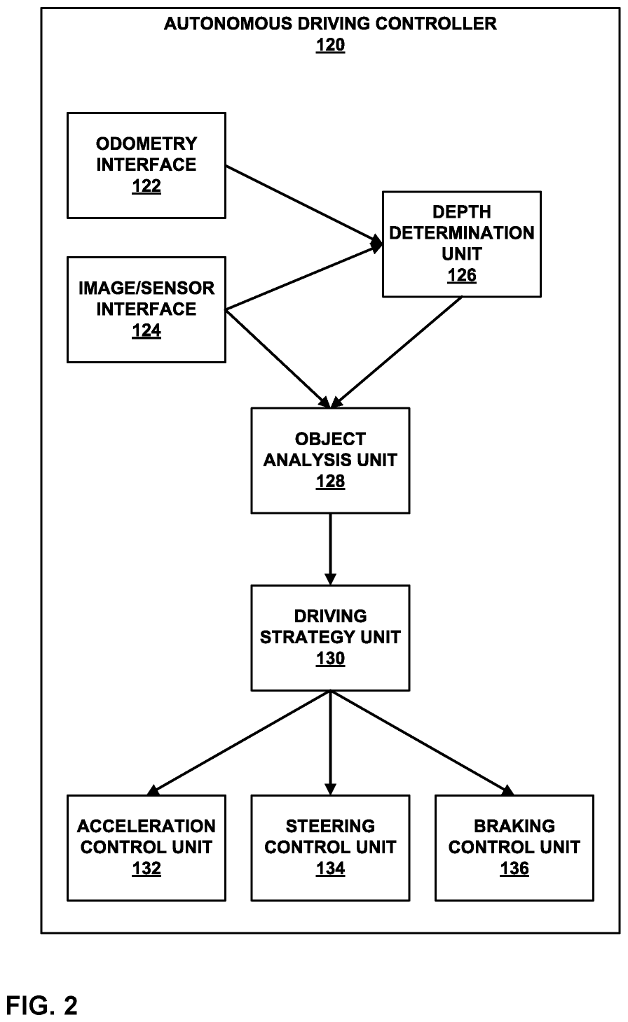

FIG. 2 is a block diagram illustrating an example set of components of autonomous driving controller 120 of FIG. 1 according to techniques of this disclosure. In this example, autonomous driving controller 120 includes odometry interface 122, image/sensor interface 124, depth determination unit 126, object analysis unit 128, driving strategy unit 130, acceleration control unit 132, steering control unit 134, and braking control unit 136.

In general, odometry interface 122 represents an interface to odometry unit 112 of FIG. 1, which receives odometry data from odometry unit 112 and provides the odometry data to depth determination unit 126. Similarly, image/sensor interface 124 represents an interface to cameras 110 and sensors 114 of FIG. 1 and provides images or other sensor data to depth determination unit 126.

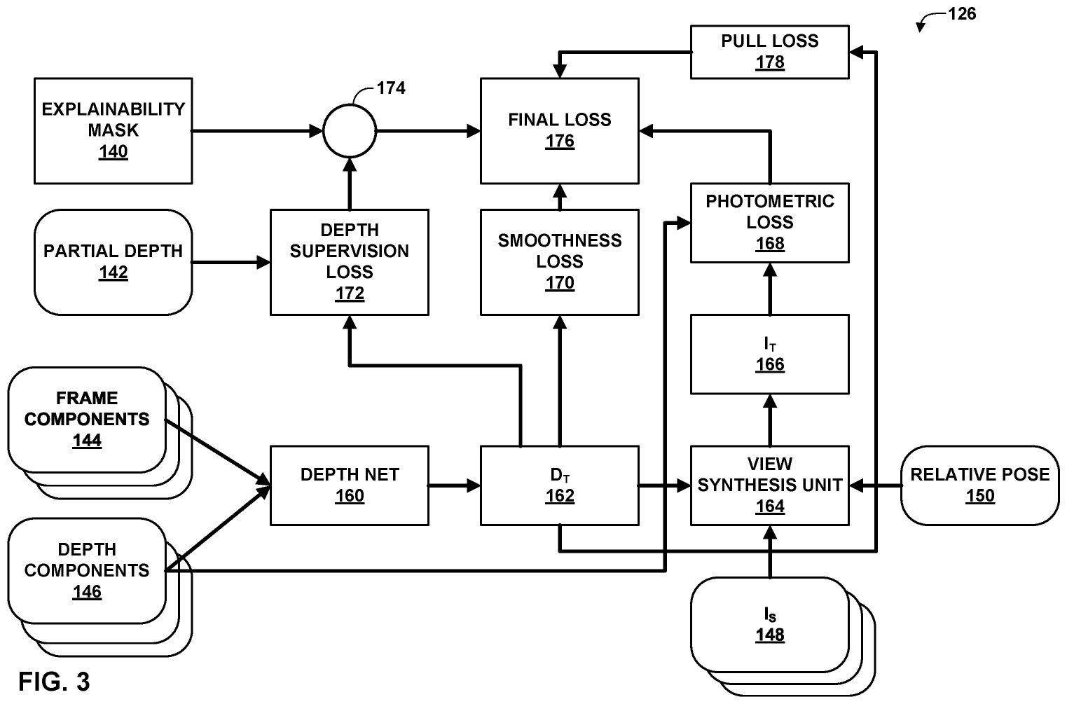

Depth determination unit 126, as explained in greater detail below with respect to FIG. 3, may determine depth of objects represented in images and other sensor data received via image/sensor interface 124 using the images themselves, other sensor data, and odometry data received via odometry interface 122.

Image/sensor interface 124 may also provide the image frames and other sensor data to object analysis unit 128. Likewise, depth determination unit 126 may provide depth values for objects in the images to object analysis unit 128. Object analysis unit 128 may generally determine where objects are relative to the position of vehicle 100 at a given time, and may also determine whether the objects are stationary or moving. Object analysis unit 128 may provide object data to driving strategy unit 130, which may determine a driving strategy based on the object data. For example, driving strategy unit 130 may determine whether to accelerate, brake, and/or turn vehicle 100. Driving strategy unit 130 may execute the determined strategy by delivering vehicle control signals to various driving systems (acceleration, braking, and/or steering) via acceleration control unit 132, steering control unit 134, and braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components of depth determination unit 126 of FIG. 2. Depth determination unit 126 includes depth net 160, D_{T} 162, view synthesis unit 164, I_{T} 166, photometric loss 168, smoothness loss 170, depth supervision loss 172, combination unit 174, final loss 176, and pull loss 178. As shown in the example of FIG. 3, depth determination unit 126 receives explainability mask 140, partial depth 142, frame components 144, depth components 146, I_{S} 148, and relative pose data 150.

Frame components 144 correspond to components (e.g., R, G, and B components or Y, U, and V/Y, Cb, and Cr components) of image frames, e.g., received from camera 110 of FIG. 1. Depth components 146 correspond to components (e.g., X, Y, and/or Z components) corresponding to differences along or about X-, Y-, and/or Z-axes between odometry data for times at which the image frames were captured. Depth net 160 represents a depth learning artificial intelligence/machine learning (AI/ML) unit, such as a neural network, trained to determine depth values for objects included in the image frames using the odometry data.

D_{T} 162 represents a depth map at time T (corresponding to the time at which the later image was captured) as calculated by depth net 160.

View synthesis unit 164 may synthesize one or more additional views using original image frames (I_{S} 148) and the depth map, i.e., D_{T} 162, as well as relative pose data 150. That is, using the depth map and relative pose data 150, view synthesis unit 164 may warp samples of the original image frames to produce one or more warped image frames, such that the samples of the original image frames are moved horizontally according to the determined depth values for the object to which the samples correspond. Relative pose data 150 may be measured or estimated by a pose network. I_{T} 166 represents the resulting warped image generated by view synthesis unit 164.

Photometric loss unit 168 may calculate photometric loss, representing photometric differences between pixels warped from the received image frames and the pixels in the warped image, i.e., I_{T} 166. Photometric loss unit 168 may provide the photometric loss to final loss unit 176.

Smoothness loss unit 170 may calculate smoothness loss of the depth map, i.e., D_{T} 162. Smoothness loss generally represents a degree to which depth values are smooth, e.g., represent geometrically natural depth. Smoothness loss unit 170 may provide the smoothness loss to final loss unit 176.

Depth supervision loss unit 172 may calculate depth supervision loss of the depth map, i.e., D_{T} 162, using partial depth data 142.

Explainability mask 140 generally represents confidence values, i.e., values indicating how confident depth net 160 is for various regions/samples of calculated depth maps, such as D_{T} 162. Thus, combination unit 174 may apply explainability mask 140 to the depth supervision loss calculated by depth supervision loss unit 172 and provide this masked input to final loss unit 176.

Pull loss unit 178 may calculate pull loss, representing a degree to which corners of an object are accurately joined in the depth map, i.e., D_{T} 162. Pull loss unit 178 may receive data representing input shapes to calculate the pull loss. Pull loss unit 178 may provide the pull loss to final loss unit 176. The pull loss may act as a prior value for depth values to get the depth values to a predetermined set, which may help with areas for which data may not be readily understandable, such as open sky.

Ultimately, final loss unit 176 may calculate final loss, representing overall accuracy of the depth map, D_{T} 162. The final loss may be minimized during an optimization process when training depth net 160. An optimizer for minimizing the final loss may be, for example, stochastic gradient descent, ADAM, NADAM, AdaGrad, or the like. During backpropagation of optimization, gradient values may flow backward through the final loss to other parts of the network.

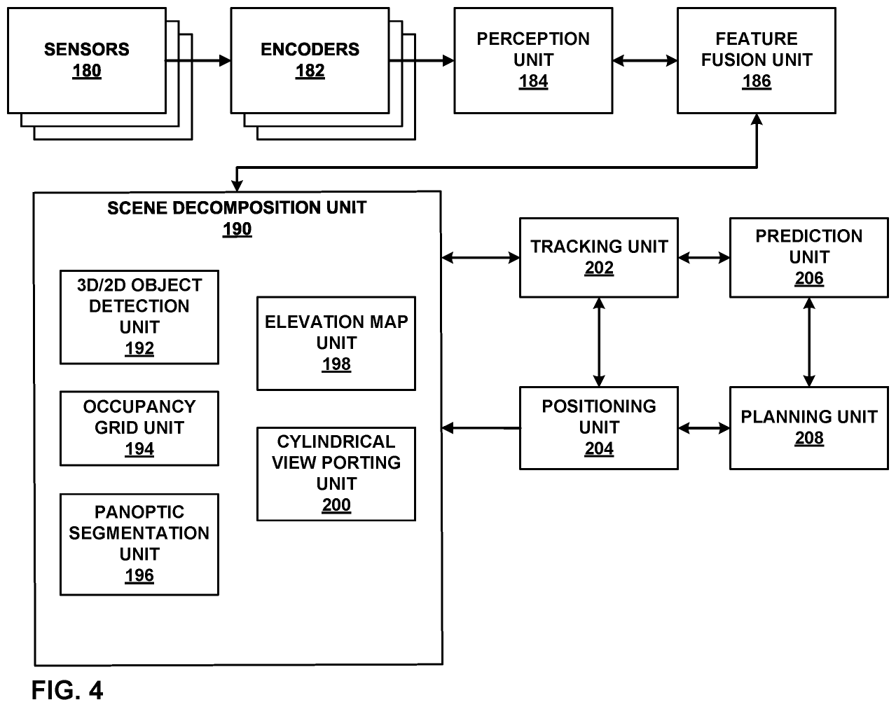

FIG. 4 is a block diagram illustrating another example set of components that may be included in autonomous driving controller 120 of FIG. 1. Sensors 180 may correspond to cameras 110 and sensors 114 of FIG. 1. In this example, autonomous driving controller 120 includes encoders 182, perception unit 184, feature fusion unit 186, scene decomposition unit 190, tracking unit 202, positioning unit 204, prediction unit 206, and planning unit 208. Scene decomposition unit 190 includes 3D/2D object detection unit 192, occupancy grid unit 194, panoptic segmentation unit 196, elevation map unit 198, and cylindrical view porting unit 200.

In general, sensors 180 collect temporal sensor data, such as images, LiDAR data, radar data, or the like. Sensors 180 pass the sensor data to encoders 182. Encoders 182 may perform self-supervised, cross-modal learning to develop models for the various sensors, e.g., cameras, LiDAR units, radar units, or the like. Such models do not require frequent updates during developments, generally.

Feature fusion unit 186 may determine features from object data represented in the various sets of sensors, and embed features to a common grid. Feature fusion unit 186 may generate a geometry tensor representing sensor configuration adaptation, e.g., locations and orientations of the various sensors. Feature fusion unit 186 may perform gated fusion to achieve functional safety (FuSa) and/or safety of the intended functionality (SOTIF). Over time, feature fusion unit 186 may perform equidistant temporal feature aggregation. Feature fusion unit 186 may perform adaptive weighting. e.g., across data received from the various sensors.

Scene decomposition unit 190 may receive fused input from feature fusion unit 186. 3D/2d object detection unit 192 and occupancy grid unit 194 may generate parametric output (e.g., boxes and/or polylines). Additionally or alternatively, panoptic segmentation unit 196 may generate non-parametric grid panoptic output. Elevation map unit 198 may use elevation models to represent non-flat road surfaces. Scene decomposition unit may determine generic objects using grid elevation and flow. Cylindrical view porting unit 200 may generate complementary cylindrical viewport output for small birds-eye view (BEV) and floating objects.

Tracking unit 202, positioning unit 204, prediction unit 206, and planning unit 208 may be configured to use abstract fused feature data, e.g., received from scene decomposition unit 190.

According to the techniques of this disclosure, the system of FIG. 4 may be trained using artificial intelligence/machine learning techniques, including end-to-end training along with feedback from downstream tasks. For example, as discussed in greater detail below, feature fusion unit 186 may receive feedback from scene decomposition unit 190, scene decomposition unit 190 may receive feedback from tracking unit 202 and/or positioning unit 204, tracking unit 202 may receive feedback from prediction unit 206, and prediction unit 206 may receive feedback from planning unit 208. Such feedback may include, for example, confidence values representing how certain each unit is that a determination of an object location is accurate.

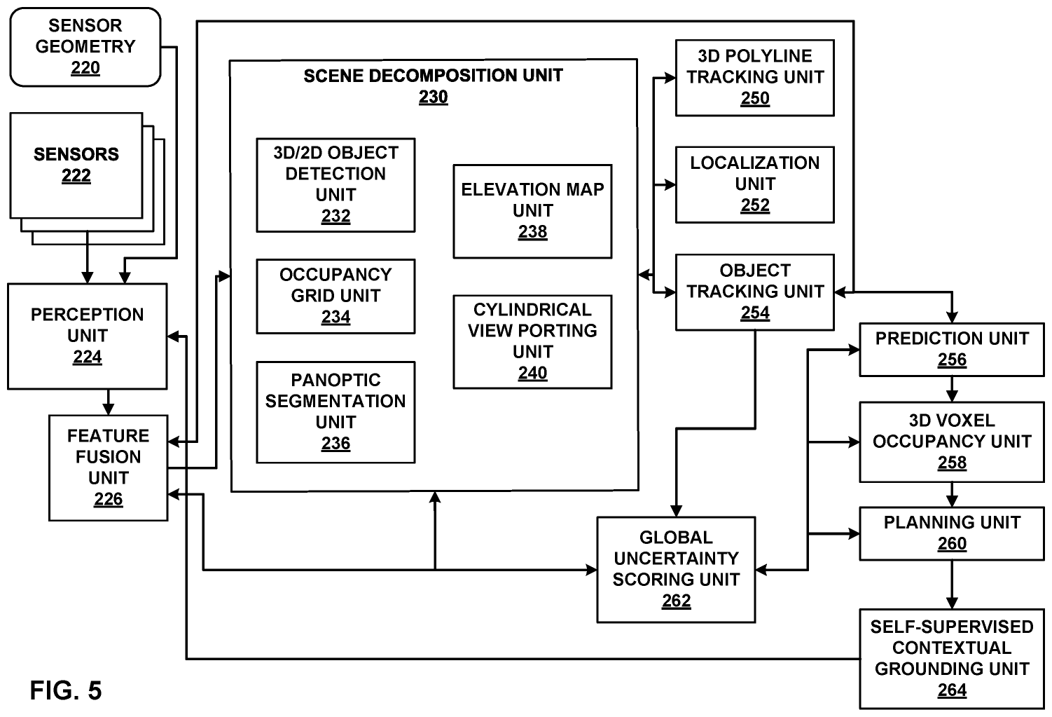

FIG. 5 is a block diagram illustrating another example set of components of autonomous driving controller 120 according to the techniques of this disclosure. In this example, autonomous driving controller 120 includes perception unit 224, feature fusion unit 226, scene decomposition unit 230, 3D polyline tracking unit 250, localization unit 252, object tracking unit 254, prediction unit 256, 3D voxel occupancy unit 258, planning unit 260, global uncertainty scoring unit 262, and self-supervised contextual grounding unit 264.

In general, perception unit 224 receives sensor data from sensors 222, which may include one or more cameras (e.g., cameras 110 of FIG. 1) and/or other sensors (e.g., sensors 114 of FIG. 1), which may include LiDAR, radar, or other such sensors. In addition, according to the techniques of this disclosure, perception unit 224 may receive sensor geometry data 220. Sensor geometry data 220 may indicate positions of the various sensors (cameras or other sensors) on vehicle 100 (FIG. 1), as well as orientations of sensors 222 if sensors 222 are directional. Sensor geometry data 220 may further indicate other data about the sensors, such as, for example, camera intrinsic such as lens focal length, lens aperture, shutter speed, ISO values, or the like.

Perception unit 224 may extract local latent features in a bird's-eye view (BEV) and cylindrical plane from data received from sensors 222 (e.g., image data, LiDAR data, radar data, or the like), along with sensor geometry data 220 indicating geometric relationships and properties of and among sensors 222. Perception unit 224 may provide the resulting feature data to feature fusion unit 226.

Feature fusion unit 226 may be a spatio-temporal, multi-view, multi-sensor fusion unit. Feature fusion unit 226 may unify the individual perception features from perception unit 224 to produce a unified BEV and cylindrical hyperplane feature. Feature fusion unit 226 may provide the unified BEV and cylindrical hyperplane feature to scene decomposition unit 230.

Scene decomposition unit 230 may feed the fused features to task-specific decoders thereof, including 3D/2D object detection unit 232, occupancy grid unit 234, panoptic segmentation unit 236, elevation map unit 238, and cylindrical view porting unit 240. Ultimately, scene decomposition unit 230 may produce a collaborate task-specific scene decomposition, with all perception features shred across tracking and prediction. The various task decoders of scene decomposition unit 230 may perform multi-task learning with one or more of a variety of weighting strategies, such as uncertainty based weighting, GradNorm weighting, dynamic task prioritization, variance norm, or the like to enable a balanced training regime.

Scene decomposition unit 230 may send outputs through a gated system to 3D polyline tracking unit 250, localization unit 252, and object tracking unit 254. Polyline tracking unit 250, localization unit 252, and object tracking unit 254 may process the data received from scene decomposition unit 230 and provide the fused information to prediction unit 256. Prediction unit 256 generates dynamic objects representing motion forecasts and provides the dynamic objects to 3D voxel occupancy unit 258. 3D voxel occupancy unit 258 generates an occupancy regression that represents a holistic 3D voxel representation of the world around vehicle 100. This gated system enables for case-adaptive selection of scene decomposition tasks, and ultimately, sensors 222, through the various neural network chains.

Ultimately, planning unit 260 may receive the 3D voxel representation and use this 3D voxel representation to make determinations as to how to at least partially autonomously control vehicle 100.

According to the techniques of this disclosure, the various units of autonomous driving controller 120, including those shown in FIG. 5, may provide feedback in the processing loop. For example, feature fusion unit 226 may receive feedback from prediction unit 256 and/or object tracking unit 254. Object tracking unit 254 may provide feedback to feature fusion unit 226 to generate a robust spatio-temporal, multi-view, multi-sensor fusion system. This may help in tracking objects around vehicle 100 across multiple views as observed by the various sensors 222 in this system.

Moreover, self-supervised contextual grounding unit 264 may receive values from planning unit 260 representing importance of various detected objects. Self-supervised contextual grounding unit 264 may construct an uncertainty matrix and provide the uncertainty matrix to perception unit 224 to allow perception unit 224 to perform a robust detection of contextually important objects.

Furthermore, feature fusion unit 226, scene decomposition unit 230, object tracking unit 254, localization unit 252, prediction unit 256, and planning unit 260 may provide data to global uncertainty scoring unit 262, to provide feedback as a unified uncertainty context across the various units. Global uncertainty scoring unit 262 may calculate a global uncertainty score and provide the global uncertainty score to, e.g., feature fusion unit 226. The global uncertainty score may be represented using one or more uncertainty maps, and global uncertainty scoring unit 262 may propagate the uncertainty maps across the various units shown in FIG. 5. In some examples, global uncertainty scoring unit 262 may score the uncertainty maps according to weights in the confidence.

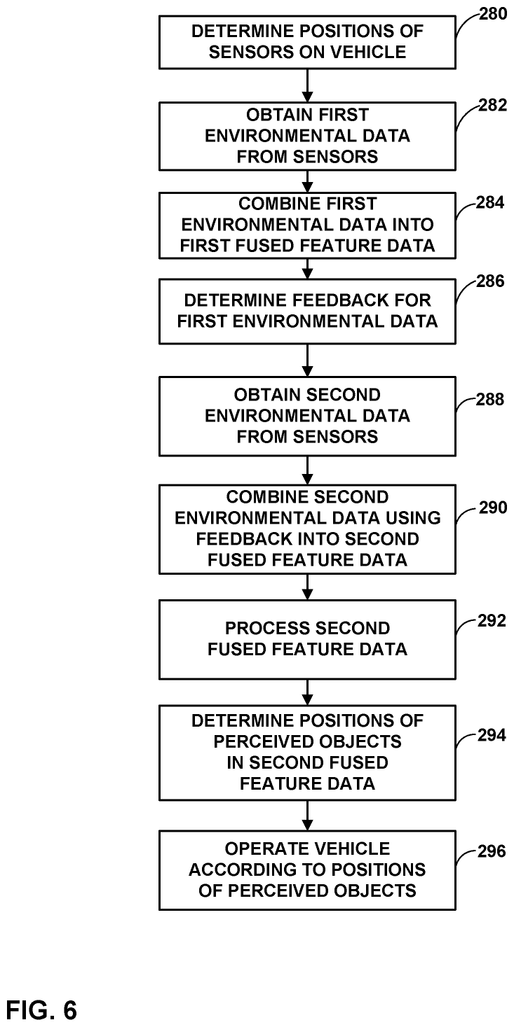

FIG. 6 is a flowchart illustrating an example method of processing sensor data of a vehicle according to techniques of this disclosure. The method of FIG. 6 is described with respect to the various components of autonomous driving controller 120 as discussed with respect to FIG. 5 for purposes of explanation.

Initially, perception unit 224 determines positions of sensors 222 (e.g., cameras 110 and sensors 114 in FIG. 1) on vehicle 100 of FIG. 1 (280). As shown in FIG. 5, sensor geometry data 220 may include data representing the positions of sensors 222. Perception unit 224 may then obtain first environmental data from sensors 222 (282). For example, perception unit 224 may receive images from various cameras, LiDAR data, radar data, or the like.

Perception unit 224 may extract features from the first environmental data based on the positions of sensors 222, then provide the features to feature fusion unit 226. Feature fusion unit 226 may then combine the features of the first environmental data into first fused feature data (284). Feature fusion unit 226 may provide the first fused feature data to scene decomposition unit 230, which may apply various task-based encoders thereof to the first fused feature data. Likewise, other subsequent units of FIG. 5 may process data output by scene decomposition unit 230. Ultimately, global uncertainty scoring unit 262 may calculate uncertainty maps, self-supervised contextual grounding unit 264 may generate an uncertainty matrix, and prediction unit 256 may generate feedback data.

Feature fusion unit 226 may receive the feedback for the first environmental data (286), and obtain second environmental data from sensors 222 (288). Feature fusion unit 226 may combine the second environmental data using the feedback into second fused feature data (290). For example, feature fusion unit 226 may operate according to an AI/ML model that is trained to accept both features for environmental data and feedback data when generating subsequent fused feature data.

Then, scene decomposition unit 230 may process the second fused feature data (292), along with other subsequent units as shown in FIG. 5. Other such units may also use the feedback data, e.g., the uncertainty maps and/or uncertainty matrices as shown in FIG. 5. Ultimately, 3D voxel occupancy unit 258 may determine positions of perceived objects in the second fused feature data (294), where the objects correspond to objects around vehicle 100, such as other cars, signs, barriers, trees or other vegetation, or the like. Planning unit 260 may then make determinations as to how best to operate vehicle 100 and operate vehicle 100 according to the positions of the perceived objects (296).

In this manner, the method of FIG. 6 represents an example of a method of processing sensor data of a vehicle including obtaining, by a perception unit of a sensor data processing system comprising one or more processors implemented in circuitry, sensor geometry information representing positions of sensors used to collect first environmental information, the sensors being positioned on the vehicle; obtaining, by the perception unit, the first environmental information around the vehicle via the sensors; combining, by a feature fusion unit of the sensor data processing system, the first environmental information from the sensors into first fused feature data representing first positions of objects around the vehicle; providing, by the feature fusion unit and to an object tracking unit of the sensor data processing system, the first fused feature data; receiving, by the feature fusion unit and from the object tracking unit, feedback for the first fused feature data; and combining, by the feature fusion unit, second environmental information from the sensors using the feedback into second fused feature data representing second positions of objects around the vehicle.

Various examples of the techniques of this disclosure are summarized in the following clauses:

Clause 1: A method of processing sensor data of a vehicle, the method comprising: obtaining, by a perception unit of a sensor data processing system comprising one or more processors implemented in circuitry, sensor geometry information representing positions of sensors used to collect first environmental information, the sensors being positioned on the vehicle; obtaining, by the perception unit, the first environmental information around the vehicle via the sensors; combining, by a feature fusion unit of the sensor data processing system, the first environmental information from the sensors into first fused feature data representing first positions of objects around the vehicle; providing, by the feature fusion unit and to an object tracking unit of the sensor data processing system, the first fused feature data; receiving, by the feature fusion unit and from the object tracking unit, feedback for the first fused feature data; and combining, by the feature fusion unit, second environmental information from the sensors using the feedback into second fused feature data representing second positions of objects around the vehicle.

Clause 2: The method of clause 1, further comprising: providing, by the feature fusion unit and to a planning unit of the sensor data processing system, the second fused feature data; and receiving, by the perception unit and from the planning unit, object importance data and uncertainty data, the object importance data representing relative importance of each of the objects around the vehicle, and the uncertainty data representing uncertainty of the objects.

Clause 3: The method of clause 1, further comprising: calculating, by a global uncertainty scoring unit of the sensor data processing system, a unified uncertainty value across the perception unit, the feature fusion unit, and the object tracking unit; and providing, by the global uncertainty scoring unit, the unified uncertainty value to the perception unit, the feature fusion unit, and the object tracking unit.

Clause 4: The method of clause 1, wherein providing the first fused feature data and the second fused feature data to the object tracking unit comprises providing the first fused feature data and the second fused feature data to a scene decomposition unit of the sensor data processing system.

Clause 5: The method of clause 4, further comprising generating, by the scene decomposition unit, a task-specific scene decomposition using one or more of a 2D/3D object detection unit of the scene decomposition unit, an occupancy grid unit, a panoptic segmentation unit, an elevation map unit, or a cylindrical view porting unit.

Clause 6: The method of clause 5, further comprising providing, by the scene decomposition unit, the task-specific scene decomposition to a tracking unit of the sensor data processing system.

Clause 7: The method of clause 1, wherein the sensor data processing system comprises an autonomous driving system or an autonomous driving assistance system (ADAS), the method further comprising at least partially controlling, by the autonomous driving system or the ADAS, operation of the vehicle using the second fused feature data.

Clause 8: A device for processing sensor data of a vehicle, the device comprising: a memory; and a sensor data processing system comprising one or more processors implemented in circuitry, the sensor data processing system comprising a perception unit, a feature fusion unit, and an object tracking unit, wherein the perception unit is configured to: obtain sensor geometry information representing positions of sensors used to collect first environmental information, the sensors being positioned on the vehicle; and obtain the first environmental information around the vehicle via the sensors, wherein the feature fusion unit is configured to: combine the first environmental information from the sensors into first fused feature data representing first positions of objects around the vehicle; provide the first fused feature data to the object tracking unit; receive feedback for the first fused feature data from the object tracking unit; and combine second environmental information from the sensors using the feedback into second fused feature data representing second positions of objects around the vehicle.

Clause 9: The device of clause 8, wherein the sensor data processing system further comprises a planning unit, wherein the feature fusion unit is configured to provide the second fused feature data to the planning unit, and wherein the perception unit is configured to receive, from the planning unit, object importance data and uncertainty data, the object importance data representing relative importance of each of the objects around the vehicle, and the uncertainty data representing uncertainty of the objects.

Clause 10: The device of clause 8, wherein the sensor data processing system further comprises a global uncertainty scoring unit configured to: calculate a unified uncertainty value across the perception unit, the feature fusion unit, and the object tracking unit; and provide the unified uncertainty value to the perception unit, the feature fusion unit, and the object tracking unit.

Clause 11: The device of clause 8, wherein the sensor data processing system further comprises a scene decomposition unit, and wherein the feature fusion unit is configured to provide the first fused feature data and the second fused feature data to the scene decomposition unit.

Clause 12: The device of clause 11, wherein the scene decomposition unit comprises one or more of a 2D/3D object detection unit of the scene decomposition unit, an occupancy grid unit, a panoptic segmentation unit, an elevation map unit, or a cylindrical view porting unit, and wherein the scene decomposition unit is configured to generate a task-specific scene decomposition.

Clause 13: The device of clause 12, wherein the sensor data processing system further comprises a tracking unit, and wherein the scene decomposition unit is configured to provide the task-specific scene decomposition to the tracking unit.

Clause 14: The device of clause 8, wherein the sensor data processing system comprises an autonomous driving system or an autonomous driving assistance system (ADAS) configured to at least partially control operation of the vehicle using the second fused feature data.

Clause 15: A device for processing sensor data of a vehicle, the device comprising: perception means for obtaining sensor geometry information representing positions of sensors used to collect first environmental information, the sensors being positioned on the vehicle, and for obtaining the first environmental information around the vehicle via the sensors; and feature fusion means for: combining the first environmental information from the sensors into first fused feature data representing first positions of objects around the vehicle; providing the first fused feature data to object tracking means; receiving, from the object tracking means, feedback for the first fused feature data; and combining second environmental information from the sensors using the feedback into second fused feature data representing second positions of objects around the vehicle.

Clause 16: The device of clause 15, further comprising planning means, wherein the feature fusion means is configured to provide the second fused feature data to the planning unit, and wherein the perception means is configured to receive, from the planning means, object importance data and uncertainty data, the object importance data representing relative importance of each of the objects around the vehicle, and the uncertainty data representing uncertainty of the objects.

Clause 17: The device of clause 15, further comprising a global uncertainty scoring means for: calculating a unified uncertainty value across the perception unit, the feature fusion unit, and the object tracking unit; and providing the unified uncertainty value to the perception means, the feature fusion means, and the object tracking means.

Clause 18: The device of clause 15, further comprising scene decomposition means, wherein the feature fusion means is configured to provide the first fused feature data and the second fused feature data to the scene decomposition means.

Clause 19: The device of clause 18, wherein the scene decomposition means is configured to generate a task-specific scene decomposition using one or more of a 2D/3D object detection means, an occupancy grid means, a panoptic segmentation means, an elevation map means, or a cylindrical view porting means.

Clause 20: The device of clause 19, wherein the scene decomposition means is configured to provide the task-specific scene decomposition to a tracking means.

Clause 21: The device of clause 15, further comprising autonomous driving means for at least partially controlling operation of the vehicle using the second fused feature data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing sensor data of a vehicle, the method comprising:
obtaining, by a perception unit of a sensor data processing system of a vehicle, the sensor data processing system comprising one or more processors implemented in circuitry, sensor geometry information representing positions of sensors used to collect first environmental information, the sensors being positioned on the vehicle;
obtaining, by the perception unit, the first environmental information around the vehicle via the sensors;
combining, by a feature fusion unit of the sensor data processing system, the first environmental information from the sensors into first fused feature data representing first positions of objects around the vehicle;
providing, by the feature fusion unit and to an object tracking unit of the sensor data processing system, the first fused feature data;
receiving, by the feature fusion unit and from the object tracking unit, feedback for the first fused feature data; and
combining, by the feature fusion unit, second environmental information from the sensors using the feedback into second fused feature data representing second positions of objects around the vehicle.

2. The method of claim 1, further comprising:
providing, by the feature fusion unit and to a planning unit of the sensor data processing system, the second fused feature data; and
receiving, by the perception unit and from the planning unit, object importance data and uncertainty data, the object importance data representing relative importance of each of the objects around the vehicle, and the uncertainty data representing uncertainty of the objects.

3. The method of claim 1, further comprising:
calculating, by a global uncertainty scoring unit of the sensor data processing system, a unified uncertainty value across the perception unit, the feature fusion unit, and the object tracking unit; and
providing, by the global uncertainty scoring unit, the unified uncertainty value to the perception unit, the feature fusion unit, and the object tracking unit.

4. The method of claim 1, wherein providing the first fused feature data and the second fused feature data to the object tracking unit comprises providing the first fused feature data and the second fused feature data to a scene decomposition unit of the sensor data processing system.

5. The method of claim 4, further comprising generating, by the scene decomposition unit, a task-specific scene decomposition using one or more of a 2D/3D object detection unit of the scene decomposition unit, an occupancy grid unit, a panoptic segmentation unit, an elevation map unit, or a cylindrical view porting unit.

6. The method of claim 5, further comprising providing, by the scene decomposition unit, the task-specific scene decomposition to a tracking unit of the sensor data processing system.

7. The method of claim 1, wherein the sensor data processing system comprises an autonomous driving system or an autonomous driving assistance system (ADAS), the method further comprising at least partially controlling, by the autonomous driving system or the ADAS, operation of the vehicle using the second fused feature data.

8. A device for processing sensor data of a vehicle, the device comprising:
a memory; and
a sensor data processing system comprising one or more processors implemented in circuitry, the sensor data processing system comprising a perception unit, a feature fusion unit, and an object tracking unit,
wherein the perception unit is configured to:
obtain sensor geometry information representing positions of sensors used to collect first environmental information, the sensors being positioned on the vehicle; and
obtain the first environmental information around the vehicle via the sensors,
wherein the feature fusion unit is configured to:
combine the first environmental information from the sensors into first fused feature data representing first positions of objects around the vehicle;
provide the first fused feature data to the object tracking unit;
receive feedback for the first fused feature data from the object tracking unit; and
combine second environmental information from the sensors using the feedback into second fused feature data representing second positions of objects around the vehicle.

9. The device of claim 8, wherein the sensor data processing system further comprises a planning unit,
wherein the feature fusion unit is configured to provide the second fused feature data to the planning unit, and
wherein the perception unit is configured to receive, from the planning unit, object importance data and uncertainty data, the object importance data representing relative importance of each of the objects around the vehicle, and the uncertainty data representing uncertainty of the objects.

10. The device of claim 8, wherein the sensor data processing system further comprises a global uncertainty scoring unit configured to:
calculate a unified uncertainty value across the perception unit, the feature fusion unit, and the object tracking unit; and
provide the unified uncertainty value to the perception unit, the feature fusion unit, and the object tracking unit.

11. The device of claim 8, wherein the sensor data processing system further comprises a scene decomposition unit, and wherein the feature fusion unit is configured to provide the first fused feature data and the second fused feature data to the scene decomposition unit.

12. The device of claim 11, wherein the scene decomposition unit comprises one or more of a 2D/3D object detection unit of the scene decomposition unit, an occupancy grid unit, a panoptic segmentation unit, an elevation map unit, or a cylindrical view porting unit, and wherein the scene decomposition unit is configured to generate a task-specific scene decomposition.

13. The device of claim 12, wherein the sensor data processing system further comprises a tracking unit, and wherein the scene decomposition unit is configured to provide the task-specific scene decomposition to the tracking unit.

14. The device of claim 8, wherein the sensor data processing system comprises an autonomous driving system or an autonomous driving assistance system (ADAS) configured to at least partially control operation of the vehicle using the second fused feature data.

15. A device for processing sensor data of a vehicle, the device comprising:
perception means for obtaining sensor geometry information representing positions of sensors used to collect first environmental information, the sensors being positioned on the vehicle, and for obtaining the first environmental information around the vehicle via the sensors; and
feature fusion means for:
combining the first environmental information from the sensors into first fused feature data representing first positions of objects around the vehicle;
providing the first fused feature data to object tracking means;
receiving, from the object tracking means, feedback for the first fused feature data; and
combining second environmental information from the sensors using the feedback into second fused feature data representing second positions of objects around the vehicle.

16. The device of claim 15, further comprising planning means,
wherein the feature fusion means is configured to provide the second fused feature data to the planning means, and
wherein the perception means is configured to receive, from the planning means, object importance data and uncertainty data, the object importance data representing relative importance of each of the objects around the vehicle, and the uncertainty data representing uncertainty of the objects.

17. The device of claim 15, further comprising a global uncertainty scoring means for:
calculating a unified uncertainty value across the perception means, the feature fusion means, and the object tracking means; and
providing the unified uncertainty value to the perception means, the feature fusion means, and the object tracking means.

18. The device of claim 15, further comprising scene decomposition means, wherein the feature fusion means is configured to provide the first fused feature data and the second fused feature data to the scene decomposition means.

19. The device of claim 18, wherein the scene decomposition means is configured to generate a task-specific scene decomposition using one or more of a 2D/3D object detection means, an occupancy grid means, a panoptic segmentation means, an elevation map means, or a cylindrical view porting means.

20. The device of claim 19, wherein the scene decomposition means is configured to provide the task-specific scene decomposition to a tracking means.

21. The device of claim 15, further comprising autonomous driving means for at least partially controlling operation of the vehicle using the second fused feature data.
